(19) United States
(12) Patent Application Publication
(10) Pub. No.: US 2025/0181041 A1
(43) Pub. Date: Jun. 5, 2025

(54) ELECTROMECHANICAL INTEGRATION ANALYSIS AND SIMULATION METHOD OF SERVO PUNCH PRESS KINEMATIC MECHANISM

(71) Applicant: Metal Industries Research & Development Centre, Kaohsiung (TW)

(72) Inventors: Ming-Fang Tsai, Yunlin County (TW); Hui-Chi Chang, Kaohsiung City (TW); Chih-Hao Lin, Kaohsiung City (TW); Fu-Chuan Hsu, Kaohsiung City (TW)

(73) Assignee: Metal Industries Research & Development Centre, Kaohsiung (TW)

(21) Appl. No.: 18/528,822

(22) Filed: Dec. 5, 2023

(51) Int. Cl. G05B 13/04; B21D 22/02

(52) U.S. Cl. CPC G05B 13/042; B21D 22/02

(57) ABSTRACT

An electromechanical integration analysis and simulation method of a servo punch press kinematic mechanism includes: constructing a model of a virtual servo punch press and a model of a virtual workpiece and importing the models into a simulation software; setting structural parameters and material parameters of the virtual servo punch press and the virtual workpiece; simulating dynamic characteristics of the virtual servo punch press and stamping characteristics of the virtual workpiece by the simulation software; establishing a simulated stamping process for press-forming the virtual workpiece by the virtual servo punch press; driving a servo punch press to press-form a workpiece by a control core, which is compared with the simulated stamping process through a simulated virtual and real comparison program to generate a comparison result; analyzing an actual motion curve of the servo punch press according to the comparison result to optimize the servo punch press.

### BACKGROUND

### Technical Field

The disclosure relates to a punch press simulation method, and more particularly to an electromechanical integration analysis and simulation method of a servo punch press kinematic mechanism.

### Description of Related Art

The level of digital system integration in current machining factories exhibits a limited extent; for instance, within the domain of mold processing, the geometric configuration of a mold, coupled with the formation curve executed by a punch press, plays a pivotal role in determining the structural robustness and practical functionality of the mold. Defects in the geometric shape directly affect the quality of products produced by the mold, while insufficient structural strength renders the mold impractical for prolonged usage.

Conventional mold processing heavily relies on the empirical knowledge of on-site technicians or employs a trial-and-error methodology to determine processing parameters for the mold and the formation curve executed by the punch press. However, the trial-and-error methodology significantly raises the production costs for the mold, and the processing parameters and formation curves derived from one instance cannot be readily applied to the development of a different set of molds. Consequently, when creating a new set of molds, the trial-and-error development process needs to be recommenced. This absence of a standardized development process and simulation of the processing parameters and the formation curves contributes to the inefficiency observed in mold development.

### SUMMARY

The disclosure provides an electromechanical integration analysis and simulation method of a servo punch press kinematic mechanism, thereby establishing a processing flow with standardized operating procedures and automated analysis simulation to enhance the development efficiency of the servo punch press and various finished products.

In an embodiment of the disclosure, an electromechanical integration analysis and simulation method of a servo punch press kinematic mechanism is provided, and the electromechanical integration analysis and simulation method includes following steps. A model of a virtual servo punch press and a model of a virtual workpiece are constructed, and the models are imported into a simulation software. Structural parameters and material parameters of the virtual servo punch press and the virtual workpiece are set. Dynamic characteristics of the virtual servo punch press and stamping characteristics of the virtual workpiece are simulated by the simulation software to establish a simulated stamping process for press-forming the virtual workpiece by the virtual servo punch press. A servo punch press is driven by a control core to press-form a workpiece, which is compared with the simulated stamping process through a simulated virtual and real comparison program to generate a comparison result. An actual motion curve of the servo punch press is analyzed based on the comparison result to optimize the servo punch press.

According to an embodiment of the disclosure, the simulated stamping process includes a servo punch press loop control simulation, a servo punch press dynamics simulation, and a servo punch press formation dynamics simulation to generate a simulated motion curve of the virtual servo punch press.

According to an embodiment of the disclosure, the structural parameters and the material parameters are analyzed by an optimization process module to obtain optimal parameters for the simulated stamping process.

According to an embodiment of the disclosure, the simulation software and the optimization process module are integrated through a rapid analysis interface, the optimal parameters are generated in the rapid analysis interface based on the structural parameters and the material parameters to automatically update the model of the virtual servo punch press, and a dynamics simulation analysis of the servo punch press and a loop control simulation analysis of the servo punch press are respectively performed.

According to an embodiment of the disclosure, the rapid analysis interface includes at least one of a graphical data interface, a text data interface, and a numeric data interface.

According to an embodiment of the disclosure, in the simulated virtual and real comparison program, the simulated motion curve is verified against the actual motion curve.

According to an embodiment of the disclosure, the simulated virtual and real comparison program includes a servo motion curve simulation analysis and a motion displacement trajectory analysis.

According to an embodiment of the disclosure, an automation design module analyzing the actual motion curve of the servo punch press based on the comparison result is further provided to assist in improving the dynamic characteristics of the servo punch press.

According to an embodiment of the disclosure, a topology optimization module optimizing the servo punch press based on the comparison result is further provided.

According to an embodiment of the disclosure, the simulation software analyzes the virtual workpiece and the virtual servo punch press by applying a finite element method (FEM).

Based on the above, the electromechanical integration analysis and simulation method of the servo punch press kinematic mechanism provided in one or more embodiments of the disclosure aims at simulating, analyzing, and evaluating the integration of the servo punch press and the workpiece to be processed. By employing the simulation software to establish the simulated stamping process for the servo punch press and the workpiece, the simulated stamping process is ultimately verified against the real workpiece press-formed by the servo punch press to confirm the accuracy of the simulation analysis and provide design feedback, thereby optimizing the processing flow of the servo punch press.

In order for the features and advantages of the disclosure to be more comprehensible, the following specific embodiments are described in detail in conjunction with the drawings.

### BRIEF DESCRIPTION OF THE DRAWINGS

The accompanying drawings, which are included to provide a further understanding of the disclosure, are incorporated in and constitute a part of this specification. The drawings illustrate embodiments of the disclosure and, together with the description, serve to explain the principles of the disclosure.

FIG. 1 is a system block diagram of an electromechanical integration analysis and simulation method of a servo punch press kinematic mechanism according to an embodiment of the disclosure.

FIG. 2 is a block flowchart of the electromechanical integration analysis and simulation method of the servo punch press kinematic mechanism depicted in FIG. 1.

### DETAILED DESCRIPTION OF DISCLOSED EMBODIMENTS

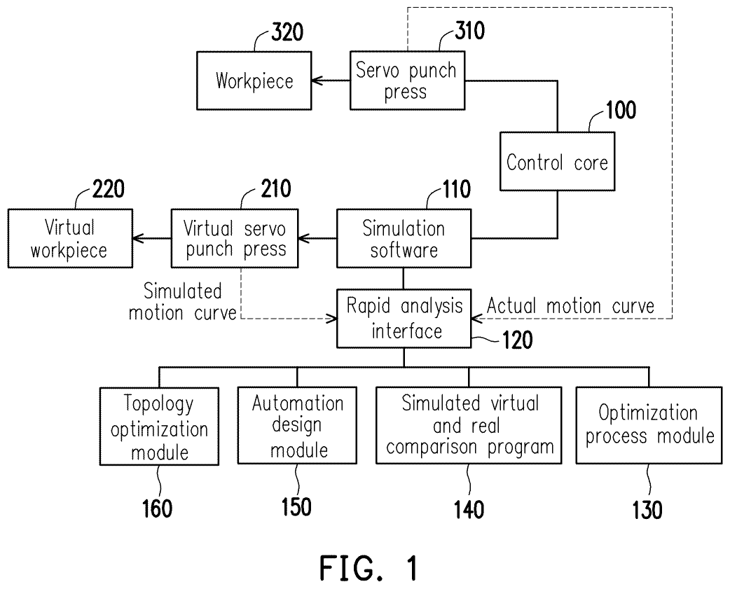

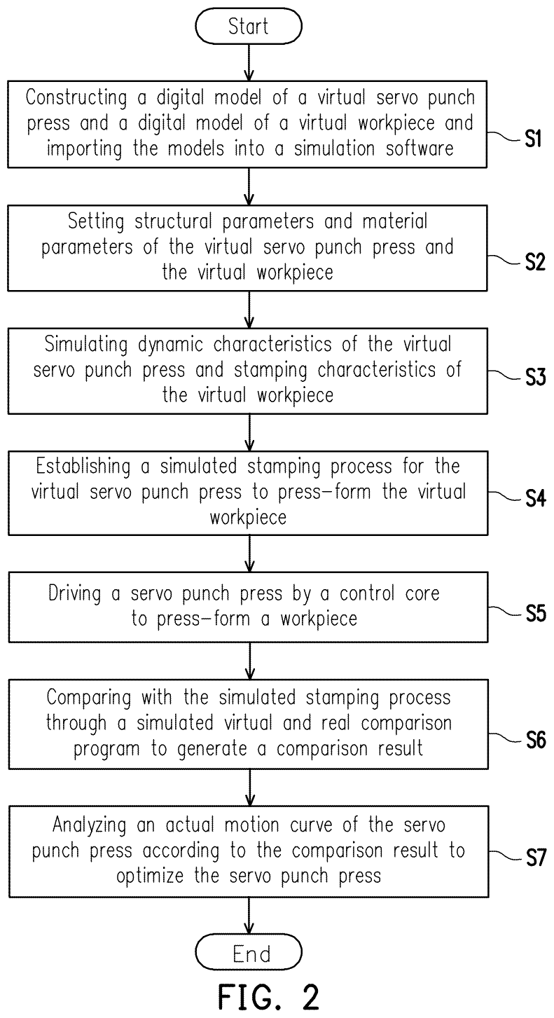

FIG. 1 is a system block diagram of an electromechanical integration analysis and simulation method of a servo punch press kinematic mechanism according to an embodiment of the disclosure. FIG. 2 is a block flowchart of the electromechanical integration analysis and simulation method of the servo punch press kinematic mechanism depicted in FIG. 1.

With reference to FIG. 1, an electromechanical integration analysis and simulation method of a servo punch press kinematic mechanism provided an embodiment of the disclosure integrates a simulation software 110 (including CAD and CAE) and various plug-in modules (130-160) through a rapid analysis interface 120 (API interface), thereby establishing a standardized operating system and steps for the mechanical processing industry to meet processing needs of various finished products.

With reference to FIG. 2, a standard process of the electromechanical integration analysis and simulation method of the servo punch press kinematic mechanism provided an embodiment of the disclosure is described as follows.

In step S1, a model of a virtual servo punch press 210 and a model of a virtual workpiece 220 are constructed, and the virtual servo punch press 210 and the virtual workpiece 220 are imported into a simulation software 110. The virtual servo punch press 210 and the virtual workpiece 220 are drawn by the CAD software, and the model of the virtual servo punch press 210 and the virtual workpiece 220 is imported into the CAE software for simulation analysis.

In step S2, structural parameters and material parameters of the virtual servo punch press 210 and the virtual workpiece 220 are set in the simulation software 110. The simulation software 110 may perform a structural analysis and a dynamics analysis based on the structural parameters and the material parameters to simulate physical phenomena and changes in physical quantities during processing. Through simulation, experimental costs and time may be saved, and the development process may be accelerated.

In step S3, the simulation software 110 simulates dynamic characteristics of the virtual servo punch press 210 and stamping characteristics of the virtual workpiece 220. Specifically, the simulation software 110 analyzes the behavior of the virtual workpiece 220 and the virtual servo punch press 210 during the stamping process by applying a finite element method (FEM), so as to predict changes in thickness, geometric shape, size, and rebound quantity of a real workpiece 320 and the virtual servo punch press 210 as references for workpiece development during the processing and formation process.

With reference to FIG. 1, in step S4, the simulation software 110 establishes a simulated stamping process for the virtual servo punch press 210 to press-form the virtual workpiece 220. The simulated stamping process includes servo punch press loop control simulation, servo punch press dynamics simulation, and servo punch press formation dynamics simulation, thereby generating a simulated motion curve of the virtual servo punch press 210, allowing product developers to know in advance a loop control simulation of the virtual servo punch press 210 and a dynamic simulation of a slider and other parts of the virtual servo punch press 210, and accordingly inspecting whether the simulated motion curve of the virtual servo punch press 210 meets the requirements.

With reference to FIG. 1, in step S5, after the simulated motion curve meets the requirements, a real machine verification may be carried out, and a control core 100 (e.g., a computer or a cloud control) drives a real servo punch press 310 to press-form the real workpiece 320.

In step S6, through a simulated virtual and real comparison program 140, a real stamping process for the servo punch press 310 to press-form the workpiece 320 is compared with the simulated stamping process to generate a comparison result.

In step S7, an actual motion curve of the servo punch press 310 is analyzed according to the comparison result, and the structure or the processing flow of the servo punch press 310 is optimized through analyzing the actual motion curve according to a numerical method.

With reference to FIG. 1, the rapid analysis interface 120 integrates the simulation software 110 and an optimization process module 130. Based on the structural parameters and the material parameters, the optimization process module 130 generates optimal parameters for the simulated stamping process in the rapid analysis interface 120 and automatically updates the model of the virtual servo punch press 210 based on the optimal parameters. A dynamics simulation analysis of the servo punch press and a loop control simulation analysis of the servo punch press are carried out, respectively, so as to obtain an optimal motion curve of the virtual servo punch press 210.

Particularly, the rapid analysis interface 120 includes at least one or all of a graphical data interface, a text data interface, and a numeric data interface. Therefore, the rapid analysis interface 120 may process different information, such as graphics, text, and numbers, which is beneficial for expanding the practical range of the rapid analysis interface 120.

With reference to FIG. 1, to be specific, in the simulated virtual and real comparison program 140, the simulated motion curve of the virtual servo punch press 210 is verified against the actual motion curve of the servo punch press 310 to obtain the comparison result. The comparison result is then transmitted to the rapid analysis interface 120, and the rapid analysis interface 120 transmits the comparison result to an automation design module 150. The automation design module 150 analyzes whether there are defects in the actual motion curve of the servo punch press 310 based on the comparison result, thereby assisting in enhancing the dynamic characteristics of the servo punch press 310 during processing. Subsequently, a topology optimization module 160 optimizes the servo punch press 310 based on the comparison result.

To sum up, the electromechanical integration analysis and simulation method of the servo punch press kinematic mechanism provided in one or more embodiments of the disclosure aims at simulating, analyzing, and evaluating the integration of the servo punch press and the workpiece to be processed. By employing the simulation software to establish the simulated stamping process for the servo punch press and the workpiece, the simulated stamping process is ultimately verified against the real workpiece press-formed by the servo punch press to confirm the accuracy of the simulation analysis and provide design feedback, thereby optimizing the processing flow of the servo punch press and the workpiece.

Additionally, the electromechanical integration analysis and simulation method of the servo punch press kinematic mechanism provided in one or more embodiments of the disclosure analyzes a slider motion curve of the servo punch press, which may assist in improving the dynamic characteristics. It is of considerable benefit to the control of high-speed or high-precision servo punch presses, and is conducive to the development of design theory and the improvement of product design efficiency, thereby enhancing the development efficiency of customized servo punch presses. Accordingly, system intelligence and the automation process of the servo punch press (processing equipment) are established.

Moreover, the electromechanical integration analysis and simulation method of the servo punch press kinematic mechanism provided in one or more embodiments of the disclosure is applicable to the industrial IoT technology. Each simulation analysis result is uploaded to the cloud, and through big data collection, a corresponding processing plan may be automatically generated according to different processing needs. Users may then make minor adjustments to shorten product development time.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electromechanical integration analysis and simulation method of a servo punch press kinematic mechanism, comprising:
constructing a model of a virtual servo punch press and a model of a virtual workpiece and importing the models into a simulation software;
setting structural parameters and material parameters of the virtual servo punch press and the virtual workpiece;
simulating dynamic characteristics of the virtual servo punch press and stamping characteristics of the virtual workpiece by the simulation software to establish a simulated stamping process for press-forming the virtual workpiece by the virtual servo punch press;
driving a servo punch press by a control core and press-forming a workpiece,
comparing the step of press-forming the workpiece with the simulated stamping process through a simulated virtual and real comparison program to generate a comparison result; and
analyzing an actual motion curve of the servo punch press based on the comparison result to optimize the servo punch press.

2. The electromechanical integration analysis and simulation method of the servo punch press kinematic mechanism according to claim 1, wherein the simulated stamping process comprises a servo punch press loop control simulation, a servo punch press dynamics simulation, and a servo punch press formation dynamics simulation to generate a simulated motion curve of the virtual servo punch press.

3. The electromechanical integration analysis and simulation method of the servo punch press kinematic mechanism according to claim 2, further comprising analyzing the structural parameters and the material parameters by an optimization process module to obtain optimal parameters for the simulated stamping process.

4. The electromechanical integration analysis and simulation method of the servo punch press kinematic mechanism according to claim 3, further comprising integrating the simulation software and the optimization process module through a rapid analysis interface, generating the optimal parameters in the rapid analysis interface based on the structural parameters and the material parameters to automatically update the model of the virtual servo punch press, and respectively performing a dynamics simulation analysis of the servo punch press and a loop control simulation analysis of the servo punch press.

5. The electromechanical integration analysis and simulation method of the servo punch press kinematic mechanism according to claim 4, wherein the rapid analysis interface comprises at least one of a graphical data interface, a text data interface, and a numeric data interface.

6. The electromechanical integration analysis and simulation method of the servo punch press kinematic mechanism according to claim 2, wherein in the simulated virtual and real comparison program, the simulated motion curve is verified against the actual motion curve.

7. The electromechanical integration analysis and simulation method of the servo punch press kinematic mechanism according to claim 6, wherein the simulated virtual and real comparison program comprises a servo motion curve simulation analysis and a motion displacement trajectory analysis.

8. The electromechanical integration analysis and simulation method of the servo punch press kinematic mechanism according to claim 1, further comprising an automation design module analyzing the actual motion curve of the servo punch press based on the comparison result to assist in improving the dynamic characteristics of the servo punch press.

9. The electromechanical integration analysis and simulation method of the servo punch press kinematic mechanism according to claim 1, further comprising a topology optimization module optimizing the servo punch press based on the comparison result.

10. The electromechanical integration analysis and simulation method of the servo punch press kinematic mechanism according to claim 1, wherein the simulation software analyzes the virtual workpiece and the virtual servo punch press by applying a finite element method.
